(19) United States
(12) Patent Application Publication
(10) Pub. No.: US 2023/0379948 A1
(43) Pub. Date: Nov. 23, 2023

(54) USER EQUIPMENT AND RESOURCE MONITORING METHOD IN SIDELINK COMMUNICATION

(71) Applicant: GUANGDONG OPPO MOBILE TELECOMMUNICATIONS CORP., LTD., Dongguan (CN)

(72) Inventor: Huei-Ming LIN, Taipei (TW)

(21) Appl. No.: 18/366,451

(22) Filed: Aug. 7, 2023

Related U.S. Application Data
(63) Continuation of application No. PCT/CN2022/084262, filed on Mar. 31, 2022.
(60) Provisional application No. 63/170,011, filed on Apr. 2, 2021.

(51) Int. Cl. H04W 72/40; H04W 72/0446; H04W 72/25

(52) U.S. Cl. CPC H04W 72/40; H04W 72/0446; H04W 72/25

(57) ABSTRACT

A user equipment (UE) and a resource monitoring method in sidelink communication are disclosed. The resource monitoring method in sidelink communication by the UE includes sensing slots of a sidelink resource pool within a monitoring window, wherein the monitoring window includes at least a time interval, and the time interval starts from a slot (n−31), a slot (m−31), or a slot (n−T_{proc,0}^{SL}−31) and ends in slot (n−T_{proc,0}^{SL}), where the UE is triggered to determine a subset of resources in a slot (n) as a part of a re-evaluation and pre-emption checking procedure, and m is a smallest candidate resource slot index after slot (n+T₃).

### CROSS REFERENCE

The present application is a continuation application of International Application No. PCT/CN2022/084262, filed Mar. 31, 2022, which claims priority to U.S. Application No. 63/170,011, filed Apr. 2, 2021, the entire disclosures of which are incorporated herein by reference.

### BACKGROUND OF DISCLOSURE

### 1. Field of the Disclosure

The present disclosure relates to the field of communication systems, and more particularly, to a user equipment (UE) and a resource monitoring method in sidelink (SL) communication, which can provide a good communication performance and/or provide high reliability.

### 2. Description of the Related Art

In the advancement of radio wireless technology for vehicle-to-everything (V2X) transmission, 5th generation (5G) new radio (NR) based sidelink (SL) communication was developed by 3rd generation partnership project (3GPP) in Release 16, which is also commonly known as NR-V2X or simply NR-V. For vehicle type user equipments (VUEs) in NR-V sidelink communication, VUEs are required to receive and monitor road safety messages transmitted from all surrounding UEs continuously, and hence, VUEs are always monitoring and searching for any physical sidelink control channel (PSCCH) transmission in every slot for receiving messages in physical sidelink shared channel (PSSCH). VUEs are effectively monitoring sidelink resource time and frequency assignment and future resource reservation/booking information all the time (i.e., in every slot of a sidelink resource pool (RP)), unless it is performing own transmission. As such, all these sensing/monitoring results can be used by VUEs as part of a resource re-evaluation and pre-emption checking procedure just before the transmission, and perform re-selection of the resource if necessary.

For pedestrian type UEs (PUEs) such as smartphones and bike helmets, however, it is considered as power constrained UEs that they are always operating on a battery which has a limited supply of power and thus provides only a limited operating time. Sidelink operation for NR-V communication in a PUE in this case is very different from a VUE, in which the PUE does not receive messages from other UEs on the road but relies on VUEs to receive its safety messages to maintain road safety. As such, if the existing full sensing mechanism adopted in the re-evaluation and pre-emption checking procedure is re-used for a PUE, it would be very costly for the PUE in terms of power consumption.

### SUMMARY

An object of the present disclosure is to propose a user equipment (UE) and a resource monitoring method in sidelink communication.

In a first aspect of the present disclosure, a user equipment (UE) includes a memory, a transceiver, and a processor coupled to the memory and the transceiver. The processor is configured to sense slots of a sidelink resource pool within a monitoring window, wherein the monitoring window includes at least a time interval, and the time interval starts from a slot (n−31), a slot (m−31), or a slot (n−T_{proc,0}^{SL}−31) and ends in slot (n−T_{proc,0}^{SL}), where the processor is triggered to determine a subset of resources in a slot (n) as a part of a re-evaluation and pre-emption checking procedure, and m is a smallest candidate resource slot index after slot (n+T₃).

In a second aspect of the present disclosure, a resource monitoring method in sidelink communication by a user equipment (UE) includes sensing slots of a sidelink resource pool within a monitoring window, wherein the monitoring window includes at least a time interval, and the time interval starts from a slot (n−31), a slot (m−31), or a slot (n−T_{proc,0}^{SL}−31) and ends in slot (n−T_{proc,0}^{SL}), where the UE is triggered to determine a subset of resources in a slot (n) as a part of a re-evaluation and pre-emption checking procedure, and m is a smallest candidate resource slot index after slot (n+T₃).

In a third aspect of the present disclosure, a user equipment (UE) includes a memory, a transceiver, and a processor coupled to the memory and the transceiver. The UE includes all available sensing results of the sidelink resource pool within a time interval for the re-evaluation and pre-emption checking procedure, wherein the time interval is after n−T₀ and/or before n−T_{proc,0}^{SL}, where a number of slots for To is determined according to a configuration parameter.

In a fourth aspect of the present disclosure, a resource monitoring method in sidelink communication by a user equipment (UE) includes including all available sensing results of the sidelink resource pool within a time interval for the re-evaluation and pre-emption checking procedure, wherein the time interval is after n−T₀ and/or before n−T_{proc,0}^{SL}, where a number of slots for T₀ is determined according to a configuration parameter.

In a fifth aspect of the present disclosure, a non-transitory machine-readable storage medium has stored thereon instructions that, when executed by a computer, cause the computer to perform the above method.

In a sixth aspect of the present disclosure, a chip includes a processor, configured to call and run a computer program stored in a memory, to cause a device in which the chip is installed to execute the above method.

In a seventh aspect of the present disclosure, a computer readable storage medium, in which a computer program is stored, causes a computer to execute the above method.

In an eighth aspect of the present disclosure, a computer program product includes a computer program, and the computer program causes a computer to execute the above method.

In a ninth aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of user equipments (UEs) of communication in a communication network system according to an embodiment of the present disclosure.

FIG. 2 is a schematic diagram illustrating an example user plane protocol stack according to an embodiment of the present disclosure.

FIG. 3 is a schematic diagram illustrating an example control plane protocol stack according to an embodiment of the present disclosure.

FIG. 4 is a flowchart illustrating a resource monitoring method in sidelink communication by a UE according to an embodiment of the present disclosure.

FIG. 5 is a flowchart illustrating a resource monitoring method in sidelink communication by a UE according to an embodiment of the present disclosure.

FIG. 6 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

In the advancement of radio wireless technology for vehicle-to-everything (V2X) transmission, 5th generation (5G) new radio (NR) based sidelink (SL) communication was developed by 3rd generation partnership project (3GPP) in Release 16, which is also commonly known as NR-V2X or simply NR-V. The NR-V of sidelink communication technology was designed and developed to support both road safety centric basic applications and advanced V2X use cases, e.g., sending basic safety and emergency warning messages directly from one vehicle to another with vehicle's direction, acceleration/braking status, types of warning, and etc., to avoid traffic accidents and to help emergency vehicles travelling safely and smoothly on the road.

As part of resource allocation mechanism when a device terminal operates in sidelink resource allocation mode 2 (as known as “UE selected” or simply “selected” mode), a previously selected and/or reserved resource by a user equipment (UE) is re-evaluated and/or pre-emption checked at least once before the UE can be used for an initial transmission or retransmission of a sidelink medium access control (MAC) protocol data unit (PDU)/transport block (TB) as to avoid collision/conflict with sidelink transmission from another UE.

In some embodiments of the present disclosure, a proposed method for resource re-evaluation and/or pre-emption checking with partial sensing in sidelink resource allocation mode 2 is disclosed. This reduces a time length and instances where a power constrained UE needs to perform a resource sensing operation to decode physical sidelink control channel (PSCCH) transmitted from other UEs in a resource pool and measure their reference signal received power (RSRP) levels.

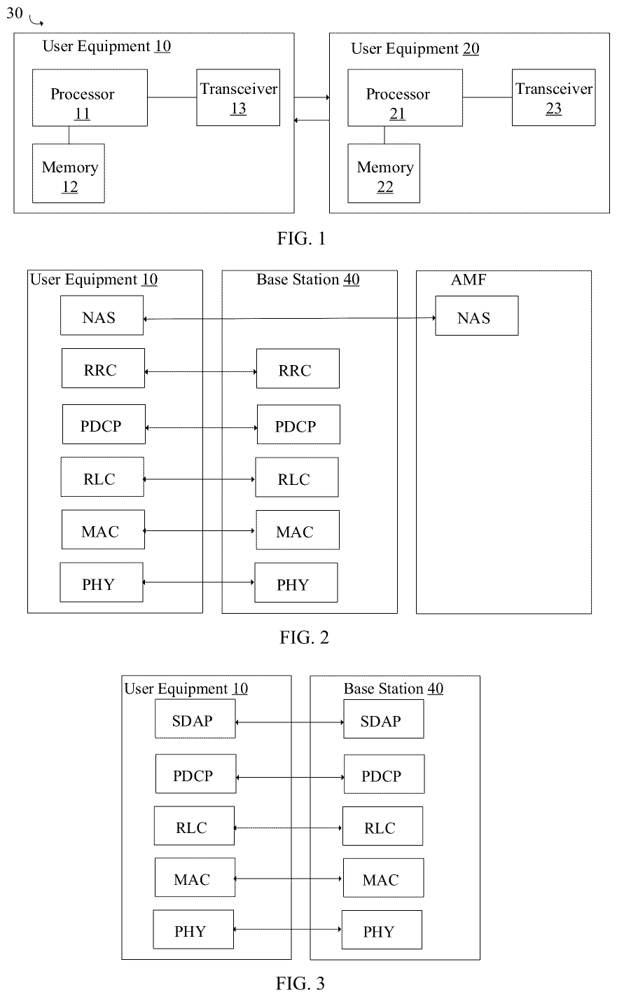

FIG. 1 illustrates that, in some embodiments, one or more user equipments (UEs) 10 (such as a first UE) and one or more user equipments (UEs) 20 (such as a second UE) of communication in a communication network system 30 according to an embodiment of the present disclosure are provided. The communication network system 30 includes one or more UEs 10 and one or more UE 20. The UE 10 may include a memory 12, a transceiver 13, and a processor 11 coupled to the memory 12 and the transceiver 13. The UE 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21 and transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

The communication between UEs relates to vehicle-to-everything (V2X) communication including vehicle-to-vehicle (V2V), vehicle-to-pedestrian (V2P), and vehicle-to-infrastructure/network (V2I/N) according to a sidelink technology developed under 3rd generation partnership project (3GPP) long term evolution (LTE) and new radio (NR) Release 17 and beyond. UEs are communicated with each other directly via a sidelink interface such as a PC5 interface. Some embodiments of the present disclosure relate to sidelink communication technology in 3GPP NR release 17 and beyond, for example providing cellular-vehicle to everything (C-V2X) communication.

In some embodiments, the UE 10 may be a sidelink packet transport block (TB) transmission UE (Tx-UE). The UE 20 may be a sidelink packet TB reception UE (Rx-UE) or a peer UE. The sidelink packet TB Rx-UE can be configured to send ACK/NACK feedback to the packet TB Tx-UE. The peer UE 20 is another UE communicating with the Tx-UE 10 in a same SL unicast or groupcast session.

FIG. 2 illustrates an example user plane protocol stack according to an embodiment of the present disclosure. FIG. 2 illustrates that, in some embodiments, in the user plane protocol stack, where service data adaptation protocol (SDAP), packet data convergence protocol (PDCP), radio link control (RLC), and media access control (MAC) sublayers and physical (PHY) layer may be terminated in a UE 10 and a base station 40 (such as gNB) on a network side. In an example, a PHY layer provides transport services to higher layers (e.g., MAC, RRC, etc.). In an example, services and functions of a MAC sublayer may comprise mapping between logical channels and transport channels, multiplexing/demultiplexing of MAC service data units (SDUs) belonging to one or different logical channels into/from transport blocks (TBs) delivered to/from the PH-Y layer, scheduling information reporting, error correction through hybrid automatic repeat request (HARQ) (e.g. one HARQ entity per carrier in case of carrier aggregation (CA)), priority handling between UEs by means of dynamic scheduling, priority handling between logical channels of one UE by means of logical channel prioritization, and/or padding. A MAC entity may support one or multiple numerologies and/or transmission timings. In an example, mapping restrictions in a logical channel prioritization may control which numerology and/or transmission timing a logical channel may use. In an example, an RLC sublayer may supports transparent mode (TM), unacknowledged mode (UM) and acknowledged mode (AM) transmission modes. The RLC configuration may be per logical channel with no dependency on numerologies and/or transmission time interval (TTI) durations. In an example, automatic repeat request (ARQ) may operate on any of the numerologies and/or TTI durations the logical channel is configured with. In an example, services and functions of the PDCP layer for the user plane may comprise sequence numbering, header compression, and decompression, transfer of user data, reordering and duplicate detection, PDCP PDU routing (e.g., in case of split bearers), retransmission of PDCP SDUs, ciphering, deciphering and integrity protection, PDCP SDU discard, PDCP re-establishment and data recovery for RLC AM, and/or duplication of PDCP PDUs. In an example, services and functions of SDAP may comprise mapping between a QoS flow and a data radio bearer. In an example, services and functions of SDAP may comprise mapping quality of service Indicator (QFI) in downlink (DL) and uplink (UL) packets. In an example, a protocol entity of SDAP may be configured for an individual PDU session.

FIG. 3 illustrates an example control plane protocol stack according to an embodiment of the present disclosure. FIG. 2 illustrates that, in some embodiments, in the control plane protocol stack where PDCP, RLC, and MAC sublayers and PHY layer may be terminated in a UE 10 and a base station 40 (such as gNB) on a network side and perform service and functions described above. In an example, RRC used to control a radio resource between the UE and a base station (such as a gNB). In an example, RRC may be terminated in a UE and the gNB on a network side. In an example, services and functions of RRC may comprise broadcast of system information related to AS and NAS, paging initiated by 5GC or RAN, establishment, maintenance and release of an RRC connection between the UE and RAN, security functions including key management, establishment, configuration, maintenance and release of signaling radio bearers (SRBs) and data radio bearers (DRBs), mobility functions, QoS management functions, UE measurement reporting and control of the reporting, detection of and recovery from radio link failure, and/or non-access stratum (NAS) message transfer to/from NAS from/to a UE. In an example, NAS control protocol may be terminated in the UE and AMF on a network side and may perform functions such as authentication, mobility management between a UE and an AMF for 3GPP access and non-3GPP access, and session management between a UE and a SMF for 3GPP access and non-3GPP access.

When a specific application is executed and a data communication service is required by the specific application in the UE, an application layer taking charge of executing the specific application provides the application-related information, that is, the application group/category/priority information/ID to the NAS layer. In this case, the application-related information may be pre-configured/defined in the UE. (Alternatively, the application-related information is received from the network to be provided from the AS (RRC) layer to the application layer, and when the application layer starts the data communication service, the application layer requests the information provision to the AS (RRC) layer to receive the information.)

In some embodiments, the processor 11 or 21 is configured to sense slots of a sidelink resource pool within a monitoring window, wherein the monitoring window includes at least a time interval, and the time interval starts from a slot (n−31), a slot (m−31), or a slot (n− T_{proc,0}^{SL}−31) and ends in slot (n−T_{proc,0}^{SL}), where the processor 11 or 21 is triggered to determine a subset of resources in a slot (n) as a part of a re-evaluation and pre-emption checking procedure, and m is a smallest candidate resource slot index after slot (n+T₃). This can solve issues in the prior art, provide power saving, avoid transmission collision, provide a good communication performance, and/or provide high reliability.

In some embodiments, the UE 10 or 20 includes all available sensing results of the sidelink resource pool within a time interval for the re-evaluation and pre-emption checking procedure, wherein the time interval for the re-evaluation and pre-emption checking procedure is after n−T₀ and/or before n−T_{proc,0}^{SL}, where a number of slots for T₀ is determined according to a configuration parameter. This can solve issues in the prior art, provide power saving, avoid transmission collision, provide a good communication performance, and/or provide high reliability.

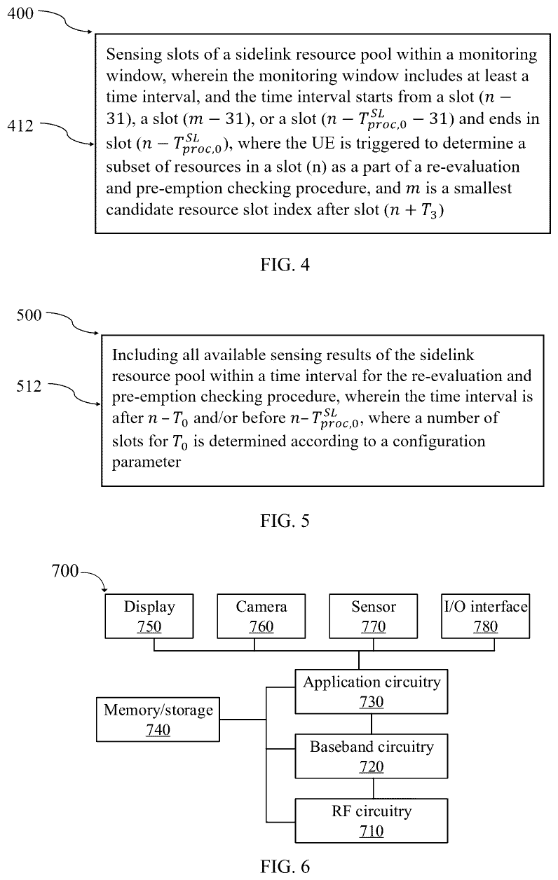

FIG. 4 illustrates a resource monitoring method 410 in sidelink communication by a user equipment (UE) according to an embodiment of the present disclosure. In some embodiments, the method 410 includes: a block 412, sensing slots of a sidelink resource pool within a monitoring window, wherein the monitoring window includes at least a time interval, and the time interval starts from a slot (n−31), a slot (m−31), or a slot (n−T_{proc,0}^{SL}−31) and ends in slot (n− T_{proc,0}^{SL}), where the UE is triggered to determine a subset of resources in a slot (n) as a part of a re-evaluation and pre-emption checking procedure, and m is a smallest candidate resource slot index after slot (n+T₃). This can solve issues in the prior art, provide power saving, avoid transmission collision, provide a good communication performance, and/or provide high reliability.

In some embodiments, a number of slots for T₃ is selected from a set of values [3, 5, 9, 17] depending on a configured subcarrier spacing (SCS) for a sidelink bandwidth part in which the sidelink resource pool is configured. In some embodiments, the UE senses the slots of the sidelink resource pool by decoding a physical sidelink control channel (PSCCH) and measuring a reference signal received power (RSRP) within the monitoring window except for slots in which its own transmissions occur. In some embodiments, a number of slots for T_{proc,0}^{SL} is selected from a set of values [1, 1, 2, 4] depending on a configured subcarrier spacing (SCS) for a sidelink bandwidth part in which the sidelink resource pool is configured. In some embodiments, the sidelink resource pool is indicated by a higher layer to a physical layer when the higher layer requests and/or triggers the physical layer in the slot (n) to determine the subset of resources from which the higher layer selects resources for a physical sidelink shared channel (PSSCH)/PSCCH transmission as the part of the re-evaluation and pre-emption checking procedure.

In some embodiments, the re-evaluation and pre-emption checking procedure comprises one or more of following parameters: a layer 1 (L1) priority of a PSSCH/PSCCH to be transmitted, a remaining packet delay budget (PDB) for the PSSCH/PSCCH transmission, and a number of sub-channels for the PSSCH/PSCCH transmission. In some embodiments, the higher layer further provides a first set of one or more resources for re-evaluation and a second set of one or more resources for pre-emption checking. In some embodiments, for the time interval of the monitoring window, a maximum resource assignment/reservation in future time slots by a sidelink control information (SCI) is limited to 31 slots. In some embodiments, the time interval starts from the slot (n−31) when the UE selects an early resource selection window. In some embodiments, the time interval starts from the slot (m−31) when the UE needs to monitor up to 31 slots prior to a first sidelink candidate resource indicated for the re-evaluation and pre-emption checking procedure. In some embodiments, the time interval starts from the slot (n−T_{proc,0}^{SL}−31) for a UE processing time for decoding the PSCCH and preparing the subset of resources to be reported to the higher layer in the slot (n).

In some embodiments, the method further includes including all available sensing results of the sidelink resource pool within a time interval for the re-evaluation and pre-emption checking procedure, wherein the time interval is after n−T₀ and/or before n−T_{proc,0}^{SL}, where a number of slots for T₀ is determined according to a configuration parameter. In some embodiments, the configuration parameter indicates a start of the monitoring window. In some embodiments, the configuration parameter is defined as 1100 ms or 100 ms. In some embodiments, a value of the configuration parameter is dependent on whether the sidelink resource pool allows to reserve a sidelink resource for another transport block (TB) in an SCI. In some embodiments, the UE initializes a set of candidate resources within a selection window and excludes resources that have been reserved by others in a received SCI format and its measured RSRP is higher than a corresponding threshold. In some embodiments, the UE reports remaining candidate resource set to the higher layer along with the following: any resource from the first set of one or more resources provided by the higher layer that is no longer part of the remaining candidate resource set as re-evaluation, and/or any resource from the second set of one or more resources provided by the higher layer that is no longer part of the remaining candidate resource set as pre-emption.

FIG. 5 illustrates a resource monitoring method 510 in sidelink communication by a user equipment (UE) according to an embodiment of the present disclosure. In some embodiments, the method 510 includes: a block 512, including all available sensing results of the sidelink resource pool within a time interval for the re-evaluation and pre-emption checking procedure, wherein the time interval is after n−T₀ and/or before n−T_{proc,0}^{SL}, where a number of slots for T₀ is determined according to a configuration parameter. This can solve issues in the prior art, provide power saving, avoid transmission collision, provide a good communication performance, and/or provide high reliability.

In some embodiments, the configuration parameter indicates a start of a monitoring window. In some embodiments, the configuration parameter is defined as 1100 ms or 100 ms. In some embodiments, a value of the configuration parameter is dependent on whether the sidelink resource pool allows to reserve a sidelink resource for another transport block (TB) in an SCI.

In some embodiments, the method further includes sensing slots of the sidelink resource pool within a monitoring window, wherein the monitoring window comprises at least a time interval, and the time interval starts from a slot (n−31), a slot (m−31), or a slot (n−T_{proc,0}^{SL}−31) and ends in slot (n−T_{proc,0}^{SL}), where the UE is triggered to determine a subset of resources in a slot (n) as a part of the re-evaluation and pre-emption checking procedure, and m is a smallest candidate resource slot index after slot (n+T₃). In some embodiments, a number of slots for T₃ is selected from a set of values [3, 5, 9, 17] depending on a configured subcarrier spacing (SCS) for a sidelink bandwidth part in which the sidelink resource pool is configured. In some embodiments, the UE senses the slots of the sidelink resource pool by decoding a physical sidelink control channel (PSCCH) and measuring a reference signal received power (RSRP) within the monitoring window except for slots in which its own transmissions occur.

In some embodiments, a number of slots for T_{proc,0}^{SL} is selected from a set of values [1, 1, 2, 4] depending on a configured subcarrier spacing (SCS) for a sidelink bandwidth part in which the sidelink resource pool is configured. In some embodiments, the sidelink resource pool is indicated by a higher layer to a physical layer when the higher layer requests and/or triggers the physical layer in the slot (n) to determine the subset of resources from which the higher layer selects resources for a physical sidelink shared channel (PSSCH)/PSCCH transmission as the part of the re-evaluation and pre-emption checking procedure. In some embodiments, the re-evaluation and pre-emption checking procedure comprises one or more of following parameters: a layer 1 (L1) priority of a PSSCH/PSCCH to be transmitted, a remaining packet delay budget (PDB) for the PSSCH/PSCCH transmission, and a number of sub-channels for the PSSCH/PSCCH transmission. In some embodiments, the higher layer further provides a first set of one or more resources for re-evaluation and a second set of one or more resources for pre-emption checking. In some embodiments, for the time interval of the monitoring window, a maximum resource assignment/reservation in future time slots by a sidelink control information (SCI) is limited to 31 slots.

In some embodiments, the time interval starts from the slot (n−31) when the UE selects an early resource selection window. In some embodiments, the time interval starts from the slot (m−31) when the UE needs to monitor up to 31 slots prior to a first sidelink candidate resource indicated for the re-evaluation and pre-emption checking procedure. In some embodiments, the time interval starts from the slot (n−T_{proc,0}^{SL}−31) for a UE processing time for decoding the PSCCH and preparing the subset of resources to be reported to the higher layer in the slot (n). In some embodiments, the UE initializes a set of candidate resources within a selection window and excludes resources that have been reserved by others in a received SCI format and its measured RSRP is higher than a corresponding threshold. In some embodiments, the UE reports remaining candidate resource set to the higher layer along with the following: any resource from the first set of one or more resources provided by the higher layer that is no longer part of the remaining candidate resource set as re-evaluation, and/or any resource from the second set of one or more resources provided by the higher layer that is no longer part of the remaining candidate resource set as pre-emption.

In some embodiments, the proposed method includes the following procedure for re-evaluation and/or pre-emption checking of sidelink resources.

When a higher layer (such as a MAC layer) requests/triggers a UE (such as a physical layer) in slot (n) to determine a subset of resources from which the higher layer may select resources for PSSCH/PSCCH transmission as a part of a re-evaluation and pre-emption procedure, the higher layer indicates a sidelink resource pool from which the subset of resources is to be reported and provides one or more of the following parameters for the procedure: L1 priority of PSSCH/PSCCH to be transmitted, remaining PDB for the PSSCH/PSCCH transmission, and/or the number of sub-channels for the PSSCH/PSCCH transmission. In some embodiments, the higher layer further provides a first set of one or more resources for re-evaluation and a second set of one or more resources for pre-emption checking.

In some embodiments, the slot (n) in which the re-evaluation or pre-emption procedure is triggered and to be perform by the UE (such as physical layer) is at T₃ before slot (m), where m is the smallest candidate resource slot index among the resources from the first set and the second set of resources. In an example, n=m−T₃. The number of slots for T₃ is selected from a set of values [3, 5, 9, 17] depending on the configured SCS for the SL bandwidth part in which the SL resource pool is configured.

Since any excessive sensing in slots that are not necessary and relevant to resource re-evaluation and pre-emption checking and it will only lead to power consumption wastage for power constrained device terminals, the UE senses slots of the indicated sidelink resource pool by decoding PSCCH and measuring RSRP within a monitoring window except for slots in which its own transmissions occur, where the monitoring window includes at least a partial time interval that starts from slot (n−31), (m−31), or (n−T_{proc,0}^{SL}−31) and/or ends in slot (n−T_{proc,0}^{SL}). In an example, slot (n−T_{proc,0}^{SL})=slot (m−T₃−T_{proc,0}^{SL}).

In some examples, T_{proc,0}^{SL} is a UE processing time for decoding PSCCH and preparing the subset of resources to be reported to the higher layer in slot (n). The number of slots for T_{proc,0}^{SL} is selected from a set of values [1, 1, 2, 4] depending on the configured subcarrier spacing (SCS) for a sidelink (SL) bandwidth part in which the SL resource pool is configured. In some examples, this monitoring window including only a partial time interval is based on a principle that the maximum resource assignment/reservation in future time slot is limited to only 31 slots, according to the existing time assignment field in a sidelink control information (SCI) format. In some examples, when the start timing of the partial sensing time interval is defined as slot (n−31), this is to account for the case when the UE selects an early resource selection window, e.g. T₁=0. In some examples, when the start timing of the partial sensing time interval is defined as slot (m−31), this is due to the fact that the UE only needs to monitor up to 31 slots prior to the first sidelink resource indicated for re-evaluation and pre-emption checking to account for aperiodic reservations. In some examples, when the start timing of the partial sensing time interval is defined as slot (n−T_{proc,0}^{SL}−31), this is to further account for the UE processing time needed for the UE processing time for decoding PSCCH and preparing the subset of resources to be reported.

In some embodiments, the UE includes also any additional/available sensing results (e.g., from periodic-based partial sensing and contiguous partial sensing performed for the initial selection of the first and second set of resources, and PSCCH decoding during sidelink-discontinued reception (SL-DRX) ON duration, if configured) from monitoring other slots belong to the resource pool within a range of slots [n−T₀, n−T_{proc,0}^{SL}), where the number of slots for To is determined according to a resource pool specific configuration parameter, SL monitoring window, which is defined as 1100 ms or 100 ms indicating the start of the monitoring window. The selection of the value may be dependent on whether the resource pool allows to reserve a sidelink resource for another TB in SCI.

In some embodiments, the UE initializes a set of all candidate resources within a selection window and excludes resources that have been reserved by others in the received SCI format and its measured RSRP is higher than a corresponding threshold. In some embodiments, the UE reports the remaining candidate resources set (the subset of resources) to the higher layer along with the following: any resource from the first set of resources provided by the higher layer that is no longer part of the remaining candidate resources set as re-evaluation, and/or any resource from the second set of resources provided by the higher layer that is no longer part of the remaining candidate resources set as pre-emption.

In summary, power saving from sensing only in slots that would include all the relevant resource time and frequency assignments and reservation information transmitted by other UEs, to avoid transmission collision. The monitoring window can be defined as follows. In some embodiments, a resource monitoring method in sidelink communication by a user equipment (UE) includes sensing slots of a sidelink resource pool within a monitoring window, wherein the monitoring window includes at least a time interval, and the time interval starts from a slot (n− 31), a slot (m−31), or a slot (n−T_{proc,0}^{SL}−31) and ends in slot (n−T_{proc,0}^{SL}), where the UE is triggered to determine a subset of resources in a slot (n) as a part of a re-evaluation and pre-emption checking procedure, and m is a smallest candidate resource slot index after slot (n+T₃). In some embodiments, a resource monitoring method in sidelink communication by a user equipment (UE) includes including all available sensing results of the sidelink resource pool within a time interval for the re-evaluation and pre-emption checking procedure, wherein the time interval is after n−T₀ and/or before n−T_{proc,0}^{SL}, where a number of slots for T₀ is determined according to a configuration parameter.

Commercial interests for some embodiments are as follows. 1. Solving issues in the prior art. 2. Providing power saving. 3. Avoiding transmission collision. 4. Providing good communication performance. 5. Providing high reliability. 6. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, smart watches, wireless earbuds, wireless headphones, communication devices, remote control vehicles, and robots for public safety use, AR/VR device maker for example gaming, conference/seminar, education purposes, smart home appliances including TV, stereo, speakers, lights, door bells, locks, cameras, conferencing headsets, and etc., smart factory and warehouse equipment including IIoT devices, robots, robotic arms, and simply just between production machines. In some embodiments, commercial interest for the disclosed invention and business importance includes lowering power consumption for wireless communication means longer operating time for the device and/or better user experience and product satisfaction from longer operating time between battery charging. Some embodiments of the present disclosure are a combination of “techniques/processes” that can be adopted in 3GPP specification to create an end product. Some embodiments of the present disclosure relate to mobile cellular communication technology in 3GPP NR Release 17 and beyond for providing direct device-to-device (D2D) wireless communication services.

FIG. 6 is a block diagram of an example system 700 for wireless communication according to an embodiment of the present disclosure. Embodiments described herein may be implemented into the system using any suitably configured hardware and/or software. FIG. 6 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated.

The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network.

In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry.

As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules.

In some embodiments, some or all of the constituent components of the baseband circuitry, the application circuitry, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, a AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product.

Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A resource monitoring method in sidelink communication by a user equipment (UE), comprising:
sensing slots of a sidelink resource pool within a monitoring window, wherein the monitoring window comprises at least a time interval, and the time interval starts from a slot (n−31), a slot (m−31), or a slot (n−T_{proc,0}^{SL}−31) and ends in slot (n−T_{proc,0}^{SL}), where the UE is triggered to determine a subset of resources in a slot (n) as a part of a re-evaluation and pre-emption checking procedure, and m is a smallest candidate resource slot index after slot (n+T₃).

2. The method of claim 1, wherein a number of slots for T₃ is selected from a set of values [3, 5, 9, 17] depending on a configured subcarrier spacing (SCS) for a sidelink bandwidth part in which the sidelink resource pool is configured.

3. The method of claim 1, wherein the UE senses the slots of the sidelink resource pool by decoding a physical sidelink control channel (PSCCH) and measuring a reference signal received power (RSRP) within the monitoring window except for slots in which its own transmissions occur.

4. The method of claim 1, wherein a number of slots for T_{proc,0}^{SL} is selected from a set of values [1, 1, 2, 4] depending on a configured subcarrier spacing (SCS) for a sidelink bandwidth part in which the sidelink resource pool is configured.

5. The method of claim 1, wherein the sidelink resource pool is indicated by a higher layer to a physical layer when the higher layer requests and/or triggers the physical layer in the slot (n) to determine the subset of resources from which the higher layer selects resources for a physical sidelink shared channel (PSSCH)/PSCCH transmission as the part of the re-evaluation and pre-emption checking procedure.

6. The method of claim 1, wherein the re-evaluation and pre-emption checking procedure comprises one or more of following parameters:
a layer 1 (L1) priority of a PSSCH/PSCCH to be transmitted;
a remaining packet delay budget (PDB) for the PSSCH/PSCCH transmission; and
a number of sub-channels for the PSSCH/PSCCH transmission.

7. The method of claim 5, wherein the higher layer further provides a first set of one or more resources for re-evaluation and a second set of one or more resources for pre-emption checking.

8. The method of claim 1, wherein for the time interval of the monitoring window, a maximum resource assignment/reservation in future time slots by a sidelink control information (SCI) is limited to 31 slots.

9. The method of claim 1, wherein the time interval starts from the slot (n−31) when the UE selects an early resource selection window.

10. The method of claim 1, wherein the time interval starts from the slot (m−31) when the UE needs to monitor up to 31 slots prior to a first sidelink candidate resource indicated for the re-evaluation and pre-emption checking procedure.

11. The method of claim 1, wherein the time interval starts from the slot (n−T_{proc,0}^{SL}−31) for a UE processing time for decoding a PSCCH and preparing the subset of resources to be reported to a higher layer in the slot (n).

12. The method of claim 1, further comprising:
including all available sensing results of the sidelink resource pool within a time interval for the re-evaluation and pre-emption checking procedure, wherein the time interval is after n−T₀ and/or before n−T_{proc,0}^{SL}, where a number of slots for T₀ is determined according to a configuration parameter.

13. The method of claim 12, wherein the configuration parameter indicates a start of the monitoring window.

14. The method of claim 13, wherein the configuration parameter is defined as 1100 ms or 100 ms.

15. The method of claim 13, wherein a value of the configuration parameter is dependent on whether the sidelink resource pool allows to reserve a sidelink resource for another transport block (TB) in an SCI.

16. The method of claim 1, wherein the UE initializes a set of candidate resources within a selection window and excludes resources that have been reserved by others in a received SCI format and its measured RSRP is higher than a corresponding threshold.

17. The method of claim 1, wherein the UE reports remaining candidate resource set to the higher layer along with the following:
any resource from a first set of one or more resources provided by the higher layer that is no longer part of the remaining candidate resource set as re-evaluation, and/or
any resource from a second set of one or more resources provided by the higher layer that is no longer part of the remaining candidate resource set as pre-emption.

18. A user equipment (UE), comprising:
a memory;
a transceiver; and
a processor coupled to the memory and the transceiver;
wherein the UE is configured to:
sense slots of a sidelink resource pool within a monitoring window, wherein the monitoring window comprises at least a time interval, and the time interval starts from a slot (n−31), a slot (m−31), or a slot (n−T_{proc,0}^{SL}−31) and ends in slot (n−T_{proc,0}^{SL}), where the UE is triggered to determine a subset of resources in a slot (n) as a part of a re-evaluation and pre-emption checking procedure, and m is a smallest candidate resource slot index after slot (n+T₃).

19. A user equipment (UE), comprising:
a memory;
a transceiver; and
a processor coupled to the memory and the transceiver;
wherein the UE is configured to:
include all available sensing results of a sidelink resource pool within a time interval for a re-evaluation and pre-emption checking procedure, wherein the time interval is after n−T₀ and/or before T_{proc,0}^{SL}, where a number of slots for T₀ is determined according to a configuration parameter.

20. The UE according to claim 19, wherein the processor is further caused to:
sense slots of the sidelink resource pool within a monitoring window, wherein the monitoring window comprises at least a time interval, and the time interval starts from a slot (n−31), a slot (m−31), or a slot (n−T_{proc,0}^{SL}−31) and ends in slot (n−T_{proc,0}^{SL}), where the UE is triggered to determine a subset of resources in a slot (n) as a part of the re-evaluation and pre-emption checking procedure, and m is a smallest candidate resource slot index after slot (n+T₃).
